(19) United States
(12) Patent Application Publication
(10) Pub. No.: US 2026/0296000 A1
(43) Pub. Date: Oct. 1, 2026

(54) Inkjet Printer and Printing System of Inkjet Printer

(71) Applicant: Hitachi Industrial Equipment Systems Co., Ltd., Chiyoda-ku, Tokyo (JP)

(72) Inventors: Takuya OTOWA, Tokyo (JP); Takashi KAWANO, Tokyo (JP); Tatsunosuke SUZUKI, Tokyo (JP); Dai AKASHI, Tokyo (JP); Shohei TERADA, Tokyo (JP); Masahiko OGINO, Tokyo (JP)

(21) Appl. No.: 18/996,379

(22) PCT Filed: May 22, 2023
(86) PCT No.: PCT/JP2023/019000

§ 371 Date: Jan. 17, 2025

(30) Foreign Application Priority Data
Dec. 14, 2022 (JP) 2022-199291

(51) Int. Cl. B41J 2/045; B41J 2/175; B41J 2/195; B41J 3/46; B41J 29/393

(52) U.S. Cl. CPC B41J 2/0457; B41J 2/04581; B41J 2/175; B41J 2/195; B41J 3/46; B41J 29/393

(57) ABSTRACT

A charging phase waveform representing a relationship between a charging phase and an amount of charge on the ink particles is measured, an excitation voltage characteristic representing a relationship between an excitation voltage and a feature amount calculated from the charging phase waveform is measured, an excitation voltage set value allowing printing is calculated based on the excitation voltage characteristic, and the calculated excitation voltage set value is transmitted to a nozzle.

### TECHNICAL FIELD

The present invention relates to an inkjet printer and a printing system of the inkjet printer.

### BACKGROUND ART

Among inkjet printers, an electrostatically controlled inkjet printer is mainly used as an industrial printer for printing serial numbers, expiration dates, etc. on products moving along a production line. In the electrostatically controlled inkjet printer, liquid ink filling an ink tank is pressurized by a pump and supplied to a nozzle of a print head.

The nozzle continuously ejects supplied ink as an ink column. However, during ejecting, a periodic vibration is imparted to the ink by applying an excitation voltage to a piezoelectric element, etc. installed adjacent to the nozzle to generate excitation. The ink column to which the vibration is imparted is cut off midway to form ink particles generated continuously (periodically) and fly at high speed.

An electrification electrode is placed at or near a position where the ink particles are formed (cut position of the ink), and an electric field is generated in this electrification electrode, thereby electrifying each ink particle flying at high speed. By applying an electric field corresponding to print content to the electrification electrode, each ink particle is given the required electrification quantity according to the print content. A deflection electrode including two electrodes to which a constant voltage is applied is placed downstream of the electrification electrode, and a flight direction of each electrified ink particle is deflected according to the electrification quantity given thereto when the ink particle flies inside the deflection electrode.

Then, the deflected ink particles are landed (attached) onto a moving print target by a conveyor, and the ink particles are printed on the print target. Note that ink particles not electrified in the electrification electrode go straight through the deflection electrode, are captured by a gutter, and are collected in an ink container as recovered ink.

In this type of inkjet printer, when a position where the ink column ejected from the nozzle is cut off to become ink particles (a distance from a tip of the nozzle to a position where ink particles are formed), that is, a “cutting position”, is not maintained at an appropriate position, the flying ink particles cannot be properly electrified by the electrification electrode, and high-quality printing cannot be achieved.

For this reason, it is important to appropriately control the cutting position so that the cutting position is within a predetermined range. It has been known that the cutting position can be adjusted by the excitation voltage applied to the piezoelectric element, etc. installed adjacent to the nozzle, and during printing, the cutting position is adjusted so that the excitation voltage that enables printing is applied to the nozzle (more specifically, the excitation voltage is applied to the piezoelectric element installed adjacent to the nozzle).

Incidentally, printing environments and print targets are diverse, and there are a plurality of types of ink that can be used for inkjet printers. Further, in addition to the type of ink, appropriate (printable) print setting content (excitation voltage, excitation frequency, pump pressure, electrification voltage, deflection voltage value, etc.) varies depending on various conditions such as the nozzle and temperature environment. As described above, when a condition of the excitation voltage applied to the nozzle is not appropriate for the type of ink and temperature, it is difficult to achieve high-precision printing, and thus at the time of printing, it is required to appropriately set the excitation voltage condition and then perform printing.

To address such an issue, a technology for determining whether the set excitation voltage condition is appropriate is disclosed, for example, in Patent Document 1. Patent Document 1 discloses a technology for acquiring a relationship between an electrification voltage applied to ink particles under a specific excitation voltage condition and a resultant electrification quantity of the ink particles, and determining whether quality of printing is favorable or poor depending on whether or not there is a proportional relationship.

### CITATION LIST

### Patent Document

Patent Document 1: JP 2019-181727 A

### SUMMARY OF THE INVENTION

### Problems to be Solved by the Invention

By using the technology of Patent Document 1, it is possible to determine whether quality of printing is favorable or poor under a specific excitation voltage condition. However, the technology of Patent Document 1 is premised on the ink quality being in an ideal state.

The quality state of the ink is affected by the materials mixed into the ink, the environment and period of storage of the ink. Even when the cutting position of the ink column is appropriate, if the quality state of the ink is poor, for example, it takes longer for the ink particles to be completely separated from the ink column, and delay occurs in a speed of a flow of charges from the ink column to the ink particles.

As a result, the quantity of electrified charges of the ink particles is insufficient, the flight direction is insufficiently deflected in the deflection electrode, and the ink particles land in positions different from those expected, resulting in poor print quality. When the ink quality state is poor, an excitation voltage range in which the print quality is favorable is not present or is extremely narrow, and thus the poor ink quality state is unsuitable for printing.

When the print quality is poor, a method of dealing with the problem thereafter differs depending on whether the problem results from a set value of the excitation voltage or the quality state of the ink. When the problem results from the set value of the excitation voltage, it is possible to improve the print quality by adjusting the excitation voltage. When the problem results from the quality state of the ink, it is possible to improve the print quality by replacing the ink.

In the technology of Patent Document 1, it is possible to determine whether the print quality is favorable or poor. However, when the print quality is determined to be poor, it is difficult to distinguish whether the cause results from the excitation voltage condition or the quality state of the ink. The cause needs to be manually distinguished, which is significantly time-consuming.

An object of the invention is to provide a highly robust inkjet printer that achieves high print quality.

### Solutions to Problems

An inkjet printer of an aspect of the invention is an inkjet printer including a main body having an ink tank storing ink, a print head configured to electrify ink particles generated by applying an excitation voltage to the ink supplied from the ink tank to a nozzle to change a trajectory of the ink particles according to an amount of charge on ink droplets, thereby performing printing using the ink particles on a print target, and a controller configured to control the print head, wherein the controller is configured to measure a charging phase waveform representing a relationship between a charging phase and the amount of charge on ink droplets, measure an excitation voltage characteristic representing a relationship between the excitation voltage and a feature amount calculated from the charging phase waveform, calculate an excitation voltage set value allowing printing based on the excitation voltage characteristic, and transmit the calculated excitation voltage set value to the nozzle.

### Effects of the Invention

According to an aspect of the invention, it is possible to provide a highly robust inkjet printer that achieves high print quality.

### BRIEF DESCRIPTION OF THE DRAWINGS

FIG. 1 is a diagram illustrating an appearance of an inkjet printer in a first embodiment.

FIG. 2 is a diagram illustrating an internal configuration of the inkjet printer in the first embodiment.

FIG. 3 is a diagram illustrating examples of a print pattern when print quality is determined to be “print quality: favorable” and “print quality: poor” in print evaluation.

FIG. 4A is a diagram illustrating an example of a relationship characteristic (charging phase waveform) between a charging phase and the amount of charge on ink droplets under an excitation voltage condition under which an ink quality state is favorable.

FIG. 4B is a diagram illustrating an example of a charging phase waveform under an excitation voltage condition under which the ink quality state is poor.

FIG. 5 is an R-V diagram of ink in a favorable ink quality state.

FIG. 6 is a diagram for describing that an excitation voltage condition under which print quality is favorable is calculated from the R-V diagram.

FIG. 7 is a diagram obtained by superimposing an excitation voltage range in which print quality is favorable on the R-V diagram of the ink in the favorable ink quality state.

FIG. 8 is a diagram for describing that the ink quality state is determined to be favorable from the R-V diagram.

FIG. 9 is an R-V diagram of ink in a poor ink quality state.

FIG. 10 is a diagram illustrating a configuration of a printing system of the inkjet printer.

FIG. 11 is a diagram illustrating content of a display screen when the ink quality state is determined to be “favorable”.

FIG. 12 is a diagram illustrating content of a display screen when the ink quality state is determined to be “poor”.

### MODE FOR CARRYING OUT THE INVENTION

The invention will be described in detail below with reference to specific embodiments. Note that the invention is not limited to the embodiments described below, and it is easily understood by those skilled in the art that a configuration thereof can be changed without departing from the technical idea or purpose of the invention. In addition, in configurations of the embodiments described below, the same reference numerals are used for the same devices and parts having similar operations and functions, and duplicated descriptions may be omitted. In addition, a position, size, shape, range, etc. of each component illustrated in the drawings are illustrated in a simplified manner to facilitate understanding of the invention, and do not represent an actual position, size, shape, range, etc. of each component.

### First Embodiment

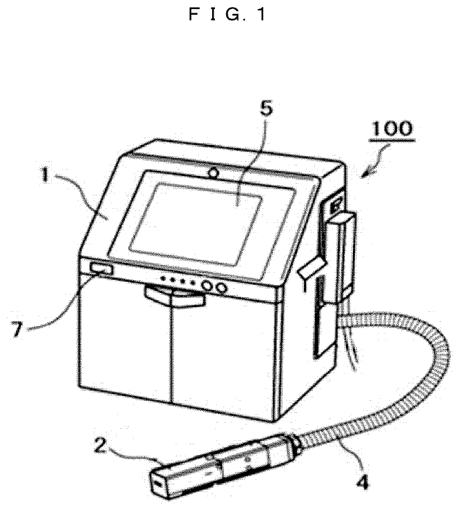

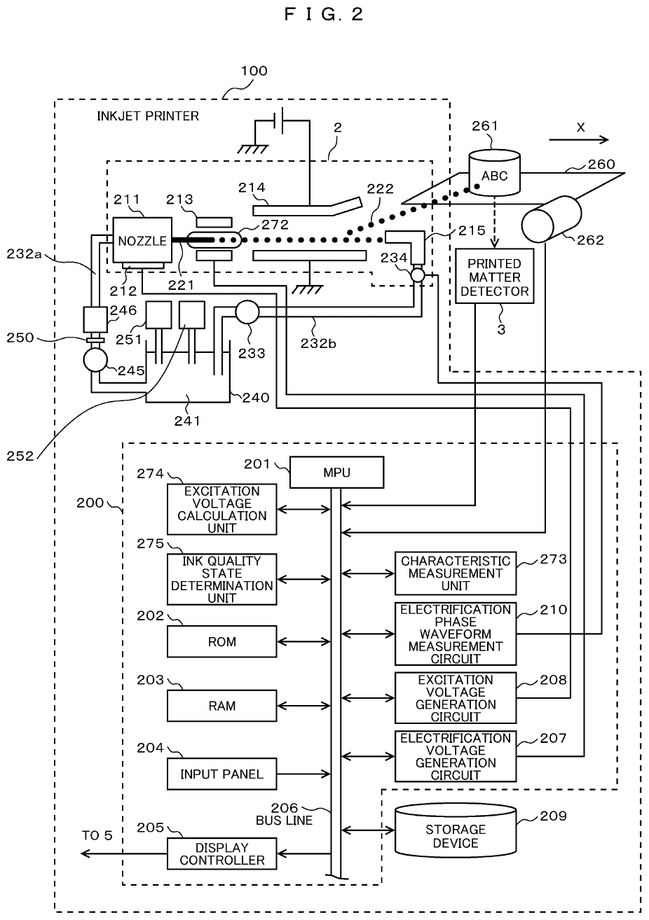

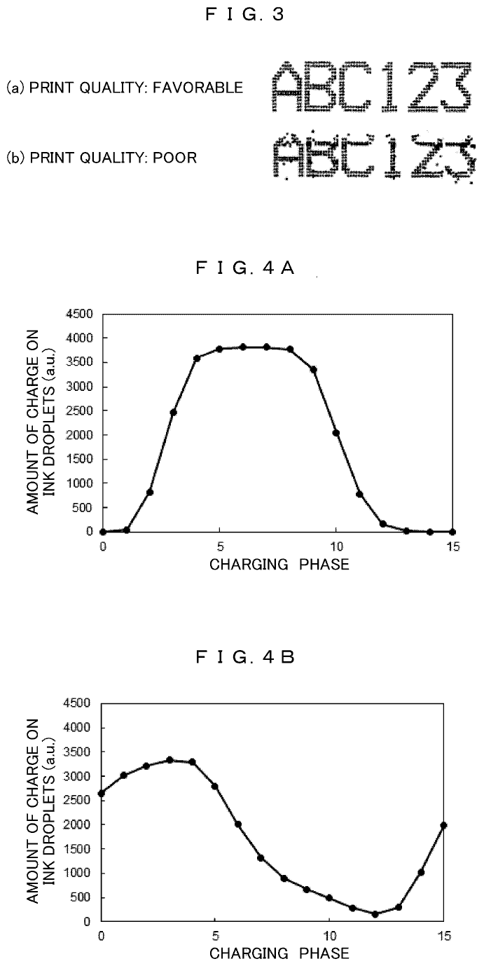

An inkjet printer in a first embodiment of the invention will be described in detail with reference to FIGS. 1 to 7. FIG. 1 is a diagram illustrating an appearance of the inkjet printer in the first embodiment, and FIG. 2 is a diagram illustrating an internal configuration of the inkjet printer in the first embodiment. £ FIGS. 3 to 7 are diagrams used to describe the first embodiment.

### Overall Configuration of Inkjet Printer

First, an outline of an overall configuration of the inkjet printer will be described with reference to FIG. 1.

In FIG. 1, the inkjet printer 100 includes a main body 1 and a print head 2. The main body 1 and the print head 2 are connected by a cable 4. The main body 1 includes therein an ink tank that stores ink for printing, a circulation pump that pumps ink from an ink container and supplies the ink to the print head 2, a pressure reducing valve that adjusts the ink to a predetermined pressure, a pipe for connection thereof, etc. The ink output from the main body 1 after being adjusted to the predetermined pressure is supplied to a nozzle in the print head 2 through the cable 4.

The print head 2 receives supply of ink, generates ink particles inside, assigns necessary charges to the ink particles, and then performs printing (dot printing) using the ink particles on a print target by deflection. In addition, a display unit 5 and a reading unit 7 are provided on a front surface of the main body 1.

The display unit 5 displays information related to an operation to be performed by a user. The display unit 5 has an input function using a touch panel on a top surface of a screen, and allows information (data) to be input by operation of the user. The reading unit 7 is provided to read information recorded on an information recording medium attached to an ink cartridge, etc. The information recording medium is, for example, an IC tag, a bar code, or a two-dimensional code (such as a QR code (registered trademark) ).

When the user performs an input operation, etc. via the display unit 5, the user may also perform an operation of bringing the IC tag of the ink cartridge close to the reading unit 7 at the same time, and thus the reading unit 7 is provided near the display unit 5. Furthermore, an internal controller 200 (not illustrated in FIG. 1), which controls information input from the display unit 5 or the reading unit 7, is provided in the main body 1. The controller 200 controls a pump, a valve, etc. in the main body 1, and controls the nozzle and an electrification electrode provided in the print head. Note that a control signal (drive signal), etc. from the controller 200 is given to the print head 2 via a line arranged in the cable 4.

### Internal Configuration of Inkjet Printer

Next, a specific configuration of the inkjet printer in the first embodiment will be described with reference to FIG. 2.

In FIG. 2, the inkjet printer 100 includes the main body 1, the print head 2, and the controller 200. In addition, a printed matter detector 3 is installed outside the inkjet printer 100. The printed matter detector 3 detects a print target 261 (product, etc.) moving on a conveying device 260, and outputs a detection signal to the controller 200. The controller 200 can optimally adjust the timing of start of printing by using this detection signal.

### Configuration of Main Body

In FIG. 2, the main body 1 is a part of the inkjet printer 100 excluding the print head 2. That is, the main body 1 in this embodiment includes an ink supplier, an ink recovery unit, and the controller 200. Note that the controller 200 may be provided outside the main body 1. The ink supplier is a device for supplying ink to the print head 2 (more directly, a nozzle 211). The “ink supplier” in this embodiment includes an ink tank 240 that contains ink 241, a circulation pump 245, a pressure reducing valve 246, a filter 250, an auxiliary ink tank 251, an intensifier tank 252, and a pipe 232a. In addition, the “ink recovery unit” recovers ink (ink particles) captured by a gutter 215 into the ink tank 240, and includes a recovery pump 233 and a pipe 232b in this embodiment.

The ink tank 240 is connected to the nozzle 211 by the pipe 232a. Meanwhile, the gutter 215 is connected to the ink tank 240 by the pipe 232b. The pipes 232a and 232b form an ink flow path. The circulation pump 245 and the pressure reducing valve 246 are provided in the middle of the pipe 232a. The filter 250 is provided between the circulation pump 245 and the pressure reducing valve 246. Note that a position of the filter 250 is not limited to the above position.

The filter is mainly intended to prevent clogging of the pipe 232a and the nozzle 211, and may be installed at any position on the pipe 232a as long as this purpose can be achieved. The ink 241 in the ink tank 240 is pumped up by the circulation pump 245 and supplied to the nozzle 211 with the pressure adjusted by the pressure reducing valve 246. The ink 241 is ink in a favorable quality state.

Furthermore, in this embodiment, the auxiliary ink tank 251 and the intensifier tank 252 are connected to the ink tank 240, and each of the tanks can be supplied. Here, the auxiliary ink tank 251 supplies ink when the ink in the ink tank is consumed. The intensifier tank 252 is used to supply an intensifier to the ink tank 240 and appropriately adjust viscosity of the ink 241. The intensifier is a liquid that replenishes a highly volatile component (solvent) contained in the ink.

### Configuration of Print Head

Next, a configuration of the print head 2 illustrated in FIG. 2 will be described in detail. The print head 2 includes the nozzle 211 that receives supply of ink pressure-fed by the pipe 232a and ejects an ink column 221. This nozzle 211 is provided with a piezoelectric element 212 (vibrator) for imparting vibrations to the ejected ink column. By applying an excitation voltage from the controller 200 to the piezoelectric element 212, vibrations are imparted to the ink column 221, cutting the ink column midway and generating ink particles 222. By applying vibrations to the ink column 221, ink particles are continuously generated to fly at high speed.

In addition, the print head 2 includes an electrification electrode 213 that forms an electric field for electrifying the ink particles 222 generated by the nozzles 211, a deflection electrode 214 that changes a trajectory of the electrified ink particles 222 depending on the electrification quantity thereof, and the gutter 215 that collects ink particles not contributing to printing. By the electrification electrode 213, charges corresponding to a shape of a character to be printed are imparted to flying ink particles, and the ink particles are electrified. The electrified ink particles fly in the deflection electrode 214. A constant voltage is applied to the deflection electrode 214, and a flight direction of each electrified ink particle is deflected depending on the electrification quantity imparted thereto when each ink particle flies in the deflection electrode.

The ink particles 222 deflected by the deflection electrode 214 fly towards the print target 261 being conveyed by the conveying device 260 and land on (adhere to) the print target 261, thereby performing printing on the print target 261. Movement of the conveying device 260 is monitored by a rotary encoder 262. The rotary encoder 262 generates a pulse signal according to a moving speed of the conveying device 260. The moving speed detected by the rotary encoder 262 is input to the controller 200 of the inkjet printer 100 and is used by the controller 200 to adjust the printing timing.

In this way, while the inkjet printer 100 is in operation, even when the print target 261 has arrived at a printing position and printing is not being performed, the ink particles 222 are continuously ejected. For this reason, the electrification control type inkjet printer 100 is also referred to as a continuous type inkjet printer.

### Configuration of Controller

Next, a description will be given of the controller 200 that controls the print head 2 and the main body 1. The controller 200 controls an excitation voltage (excitation voltage value and excitation frequency) applied to the nozzle 211 (more specifically, the piezoelectric element 212), an electrification voltage applied to the electrification electrode, a deflection voltage applied to the deflection electrode, the pressure of ink supplied to the nozzle, etc. in accordance with set software parameters. Note that, in the following, detailed descriptions of control of the ink supplier and the ink recovery unit of the main body 1 not directly related to the description of the invention will be omitted.

First, the controller 200 in this embodiment includes an MPU 201 (microprocessing unit) that executes arithmetic processing for controlling the main body 1 and the print head 2, a ROM 202 (read-only memory) that stores control programs and data necessary for operation of the MPU 201, and a RAM 203 (random access memory) that temporarily stores data required during program execution. Ink information of the ink 241 and software parameter values optimal for control are recorded in the ROM 202. The ink information includes, for example, information related to an ink type name or a solvent of the ink 241. In software used for printing control of the ink 241 and operation control of the inkjet printer, various parameter values are set for printing control.

In addition, the controller 200 includes an input panel 204 for inputting print content, a set value, etc., and a display controller 205. The input panel 204 corresponds to a touch panel of the display unit 5. The display controller 205 controls content to be displayed on the display unit 5, such as input data and print content.

Note that the controller 200 is provided with a bus line 206. The MPU 201, the ROM 202, the RAM 203, the input panel 204, and the display controller 205 are connected via the bus line 206, and signals can be transmitted and received between the devices. In addition, other devices in the controller 200, which will be described below, are also connected to the bus line 206 in the same manner, and the devices are configured to be able to mutually transmit and receive data therebetween. The bus line 206 also has a function of transmitting a data signal, an address signal, and a control signal of the MPU 201.

In addition, the controller 200 is connectable to a storage device 209 (storage unit) that stores programs, print data, etc. The controller 200 stores information (data) stored in the storage device 209 in the internal RAM 203. A representative example of the storage device 209 is USB memory. The controller 200 controls the excitation voltage (excitation voltage value and excitation frequency), pump pressure, electrification voltage, deflection voltage, etc. in accordance with set software parameters.

In addition, the controller 200 includes an electrification voltage generation circuit 207 and an excitation voltage generation circuit 208. The electrification voltage generation circuit 207 applies a voltage to the electrification electrode 213 such that charges applied to the ink particles 222 correspond to a character signal. The excitation voltage generation circuit 208 generates a high-frequency excitation voltage to be applied to the piezoelectric element 212 provided in the nozzle 211. As described later, an excitation voltage that guarantees an excitation voltage condition allowing printing calculated by an excitation voltage calculation unit 274 is selected as this excitation voltage.

By applying an excitation voltage to the piezoelectric element 212, the ink column 221 immediately after being ejected from the nozzle 211 can be vibrated to continuously generate ink particles. The electrification voltage generation circuit 207 and the excitation voltage generation circuit 208 are also connected to the bus line 206.

Furthermore, in this embodiment, the controller 200 includes a charging phase waveform measurement circuit 210 that measures a charging phase waveform, a characteristic measurement unit 273 that measures characteristics indicating a relationship between a feature amount of the charging phase waveform and an excitation voltage, an excitation voltage calculation unit 274 that calculates an optimal excitation voltage condition, and an ink quality state determination unit 275 that determines whether the quality state of the ink 241 is favorable or poor. The optimal excitation voltage condition is calculated by the characteristic measurement unit 273, the excitation voltage calculation unit 274, and the ink quality state determination unit 275. A specific method of calculating the optimal excitation voltage condition and a method of determining the ink quality state will be described later.

The charging phase waveform measurement circuit 210 has a function of dividing one period of vibration generated by the piezoelectric element 212 into, for example, 16 phases, and automatically determining timing (phase) at which electric field application is most suitable for electrifying the ink particles. Specifically, first, a weak electric field that does not affect printing is applied to ejected ink particles at each phase by the electrification electrode 213, ink particles having a weak electrification quantity with respect to the ink under each phase condition are sucked by the gutter 215, then the weak electrification quantity of the ink particles is measured by an electrification quantity measurement unit 234 provided in the middle of the ink recovery pipe 232b, and a charging phase waveform in which a horizontal axis represents phase and a vertical axis represents an amount of charge on the ink particles (an amount of charge on ink droplets) is measured. Next, from the measured charging phase waveform, a phase when the electrification quantity is the highest is detected (determined) as the optimal phase.

Printing evaluation was performed under designated pressure and excitation frequency conditions, and an excitation voltage range for favorable print quality of the ink 241 was experimentally determined. In FIG. 3, (a) indicates a normal printing state, and (b) indicates an abnormal printing state. By visual inspection, the case where the ink particles land at specified positions on a print base material (print target) and characters can be drawn was determined as “favorable print quality”, and the case where the ink particles do not land at specified positions on a print base material and characters cannot be drawn was determined as “poor print quality”. As a result of evaluation, the excitation voltage range for favorable print quality of the ink 241 was 100 to 210 V, and the print quality was poor under other excitation voltage conditions.

FIG. 4A illustrates an example of a charging phase waveform of the ink 241 at 150 V, which is an excitation voltage condition under which print quality is favorable, and FIG. 4B illustrates an example of a charging phase waveform of the ink 241 at 30 V, which is an excitation voltage condition under which print quality is poor. The waveform of FIG. 4B is gentler than that of FIG. 4A, and it was discovered that a shape of the charging phase waveform greatly differs depending on whether the print quality is favorable or poor.

Therefore, in the first embodiment, taking this characteristic into consideration, extracting a feature amount quantitatively representing a difference in waveform shape from a charging phase waveform under each excitation voltage condition, and measuring a correspondence relationship between the feature amount and the excitation voltage using the characteristic measurement unit 273 of the controller 200 was considered. In this specification, a characteristic that indicates the correspondence relationship between the feature amount of the charging phase waveform and the excitation voltage is referred to as “R-V characteristic”.

This R-V characteristic is a characteristic that represents the correspondence relationship between the feature amount extracted from the charging phase waveform and the excitation voltage, and it is easy to understand when the R-V characteristic is represented as a diagram obtained by plotting the correspondence relationship on a graph. The R-V characteristic represented as a diagram is referred to as an “R-V diagram”. In the following description, the characteristic measurement unit 273 is described as measuring the R-V diagram. Note that, even though the embodiment is described using the R-V diagram in the following description, a measurement method using the R-V diagram is only one example. The invention can be implemented when the R-V characteristic can be obtained.

### Method of Measuring R-V Diagram

Next, a specific method of measuring the R-V diagram will be described. The characteristic measurement unit 273 measures an R-V diagram representing a relationship between the excitation voltage and the feature amount extracted from the charging phase waveform, whose horizontal axis is phase and whose vertical axis is electrification quantity of ink particles, measured by the charging phase waveform measurement circuit 210. There is no particular restriction on a method of extracting the feature amount from the charging phase waveform as long as the method calculates an index that can quantitatively express a difference in charging phase waveform between excitation voltage conditions.

Examples of the method of extracting the feature amount from the charging phase waveform include calculating a peak ratio of a maximum value to a minimum value of the electrification quantity of each phase, calculating a standard deviation of the electrification quantity of each phase, Fourier series expansion of the charging phase waveform, etc. From a viewpoint of ease of calculation, the peak ratio of the maximum value to the minimum value of the charging phase waveform is most preferable as the feature amount of the charging phase waveform. Therefore, in the characteristic measurement unit 273, the peak ratio of the maximum value to the minimum value of the charging phase waveform is extracted as the feature amount of the charging phase waveform.

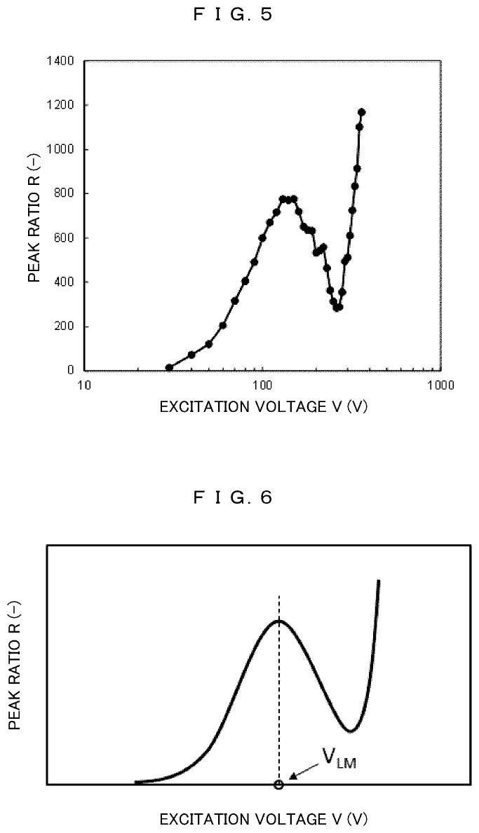

First, in the inkjet printer 100 filled with the ink 241, the charging phase waveform under each excitation voltage condition was measured by the charging phase waveform measurement circuit 210 under the designated pressure and excitation frequency conditions. Next, the peak ratio R was calculated from the maximum value and the minimum value of the electrification quantity of the charging phase waveform under each excitation voltage condition by the characteristic measurement unit 273, and the R-V diagram was measured. A measurement result of the R-V diagram created by the characteristic measurement unit 273 is illustrated in FIG. 5.

As can be seen from the R-V diagram illustrated in FIG. 5, in the feature amount R, a maximum point appears when the excitation voltage is increased, and a minimum point is observed when the excitation voltage is further increased. Note that, depending on the measured excitation voltage range and other conditions, the minimum point may not be observed.

### Method of Calculating Excitation Voltage Condition Under Which Print Quality is Favorable

Next, a description will be given of a method of calculating calculation content of the excitation voltage calculation unit 274 illustrated in FIG. 2, that is, a method of calculating an excitation voltage condition under which print quality is favorable.

As described above, the excitation voltage range under which print quality is favorable differs depending on the type of ink filling the inkjet printer 100. As a result of examining the R-V diagram and the excitation voltage range under which print quality is favorable for each type of ink in relation to this difference, a characteristic was found in which the excitation voltage condition at the maximum point of the R-V diagram falls within the excitation voltage range in which print quality is favorable.

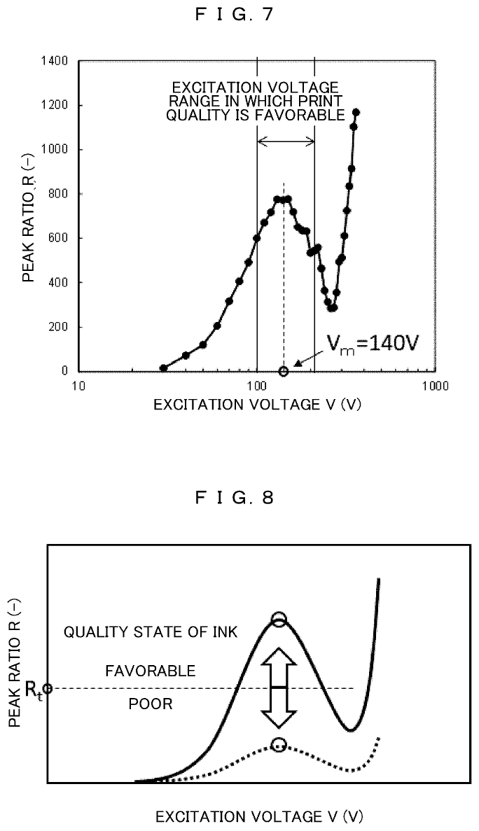

Therefore, in the first embodiment, a description is given of a method of obtaining the excitation voltage range under which print quality of the ink 241 is favorable from the R-V diagram (R-V characteristic) of the ink 241 taking this characteristic into consideration with reference to FIG. 7. The R-V diagram (R-V characteristic) of the ink 241 is measured by the characteristic measurement unit 273 using the measurement method described above. In the first embodiment, the R-V diagram (R-V characteristic) is stored in the memory (the ROM 202 or the RAM 203) inside the controller 200.

The excitation voltage calculation unit 274 can read the R-V diagram of the ink 241 from the ROM 202 or the RAM 203, and estimate and calculate an excitation voltage Vm at the maximum point of the R-V diagram as the excitation voltage condition under which print quality is favorable. The estimated and calculated excitation voltage condition can be used as a set value of the excitation voltage.

To confirm validity of this estimation and calculation, the excitation voltage condition under which print quality of the ink 241 is favorable was compared with a position of the maximum point of the R-V diagram. As described above, the excitation voltage condition under which print quality of the ink 241 is favorable was 100 to 210 V. A diagram obtained by superimposing the excitation voltage condition under which print quality is favorable on the R-V diagram of FIG. 5 is illustrated in FIG. 7.

The maximum point of the R-V diagram of the ink 241 is 140 V, which falls within the excitation voltage condition under which print quality is favorable. From the above, it was confirmed that the excitation voltage condition under which print quality is favorable can be correctly estimated by using the excitation voltage value at the maximum point of the R-V diagram as a set value of the excitation voltage.

As described above, according to the first embodiment of the invention, when the excitation voltage condition under which print quality is favorable is estimated from the excitation voltage value at the maximum value of the R-V diagram and applied a print setting condition of the inkjet printer, it is possible to a highly robust inkjet printer that achieves high print quality. Note that it is similarly possible to estimate and calculate the excitation voltage condition under which print quality is favorable from the minimum point by using a relative positional relationship between the maximum point and the minimum point.

Note that, even though an example in which the controller 200 includes the characteristic measurement unit 273, the excitation voltage calculation unit 274, and the ink quality state determination unit 275 is illustrated in the above-mentioned first embodiment (FIG. 2), the invention is not necessarily bound to such a configuration.

That is, in the above-mentioned first embodiment, the characteristic measurement unit 273, the excitation voltage calculation unit 274, and the ink quality state determination unit 275 are provided in the controller 200 for easy of understanding. However, instead, the MPU 201 of the controller 200 may have arithmetic processing functions of the characteristic measurement unit 273, the excitation voltage calculation unit 274, and the ink quality state determination unit 275. In this case, the characteristic measurement unit 273, the excitation voltage calculation unit 274, and the ink quality state determination unit 275 become unnecessary, and the configuration of the controller 200 can be simplified. This description is similarly applied to the following embodiments.

### Second Embodiment

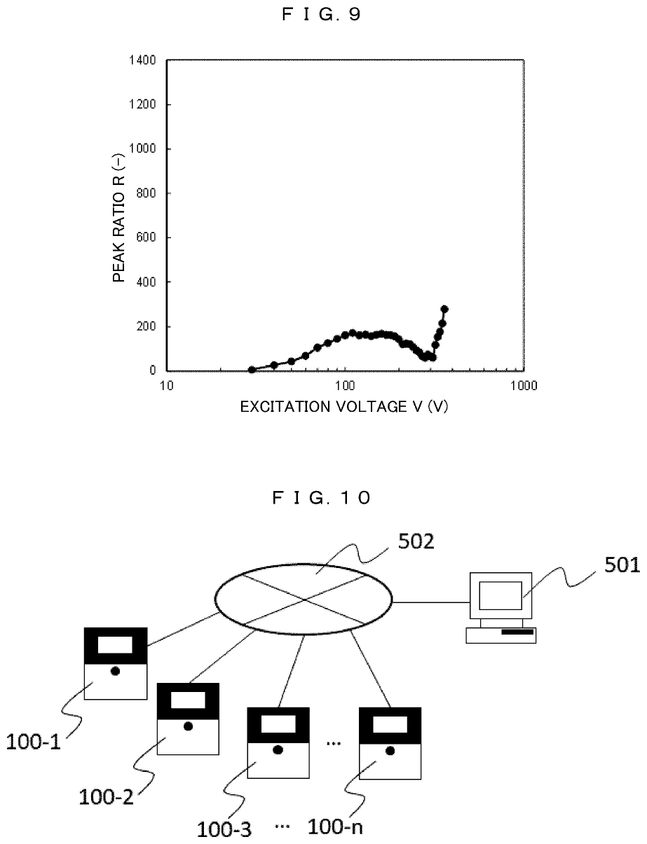

Next, a second embodiment of the invention will be described. Since the second embodiment has a basically similar configuration to that of the first embodiment, the following description will focus on differences from the first embodiment. FIGS. 8 and 9 are diagrams for describing the second embodiment of the invention in a simplified manner.

In the second embodiment, the quality state of the ink is determined from the R-V diagram measured in the first embodiment. As described above, in the case of ink having poor quality, even when the cutting position of the ink column is appropriate, the amount of charge on the ink particles is insufficient, and the ink particles land in positions different from those expected. For this reason, the excitation voltage condition under which print quality is favorable is not present or is extremely narrow, and thus the ink is unsuitable for printing.

As a result of comparing and examining R-V diagrams measured by filling the inkjet printer 100 with ink in different quality states, a characteristic was found in which a value of a peak ratio R at a maximum point of an R-V diagram differs depending on the quality state of the ink such that the value of the peak ratio R is high when the quality state of the ink is favorable, and the value of the peak ratio R is low when the quality state of the ink is poor.

Therefore, in the second embodiment, a method of determining a quality state of ink from an R-V diagram (R-V characteristic) based on this characteristic will be described with reference to FIG. 8. The inkjet printer 100 is filled with ink whose quality state is desired to be determined, and the R-V diagram is measured by the characteristic measurement unit 273.

In the second embodiment, a maximum value Rm of the peak ratio of the R-V diagram (R-V characteristic) is stored in the memory (the ROM 202 or the RAM 203) in the controller 200. The ink quality state determination unit 275 compares Rm with a threshold value Rt of the maximum value of the peak ratio previously recorded in the memory (the ROM 202 or the RAM 203) in the controller 200, and it is possible to determine that the ink quality state is “favorable” when Rm is high and the ink quality state is “poor” when Rm is low.

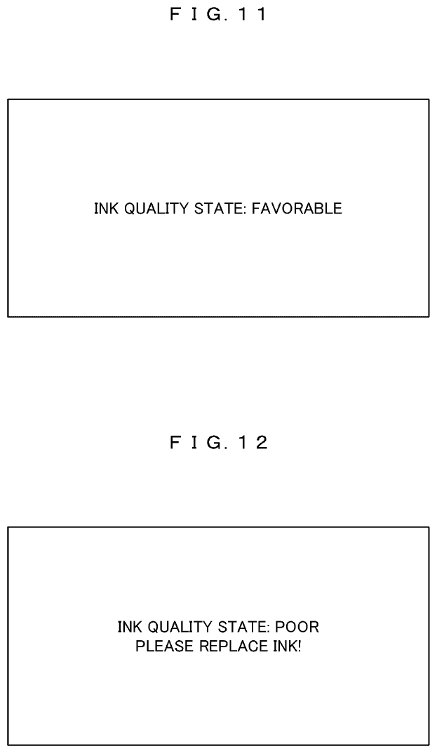

FIG. 11 is a display screen illustrating a determination result of an ink quality state, and illustrates content of the display screen when the ink quality state is determined to be “favorable” . FIG. 12 is a display screen illustrating a determination result of an ink quality state, and illustrates content of the display screen when the ink quality state is determined to be “poor”.

This determination result can be used to diagnose the quality state of the ink, and when the quality state of the ink is determined to be “poor”, a dialogue box urging the user to replace the ink with ink in a favorable quality state can be displayed on the display unit 5 of the inkjet printer 100. Note that a value of the threshold value Rt of the peak ratio can be arbitrarily set depending on the accuracy of the electrification quantity measurement unit 234 for ink particles in the inkjet printer 100 and the allowable ink quality state.

To confirm validity of this method of determining the ink quality state, first, the threshold value Rt of the peak ratio was set from the R-V diagram of FIG. 5 measured by filling the inkjet printer 100 with the ink 241 known to be in a favorable ink quality state.

Since the value of the peak ratio at the maximum value was 776, the threshold value of the peak ratio was set to a lower value of Rt=500. Next, the R-V diagram was measured by filling the inkjet printer 100 with ink 242, which has the same viscosity as that of the ink 241 and is known to be in a poor ink quality state. The R-V diagram of the ink 242 is illustrated in FIG. 9.

Since the value of the peak ratio at the maximum value of the R-V diagram of the ink 242 was 171, which was lower than Rt, the ink quality state determination unit 275 was able to correctly determine that the ink quality state was “poor”.

As described above, according to the second embodiment of the invention, it is possible to provide a highly robust inkjet printer that realizes high print quality by determining the quality state of the ink from the value of R at the maximum value of the R-V diagram, and encouraging replacement of the ink when the quality state of the ink is determined to be poor. Note that it is similarly possible to determine the quality state of the ink from the minimum point of the R-V diagram.

### Third Embodiment

Next, a third embodiment of the invention will be described. Since the third embodiment has a basically similar configuration to that of the first and second embodiments, the following description will focus on differences from the first and second embodiments.

The third embodiment differs from the first and second embodiments in that, in the inkjet printer 100 filled with the ink 241, (1) the characteristic measurement unit 273 measures the R-V diagram, (2) the set value of the excitation voltage is updated under an excitation voltage condition under which print quality is favorable estimated from the R-V diagram by the excitation voltage calculation unit 274, and (3) the ink quality state is determined from the R-V diagram by the ink quality state determination unit 275, and is displayed as a diagnosis result of the ink quality state on the display unit 5. Then, a sequence of (1) to (3) is automatically and periodically executed.

There are no particular limitations on the timing for executing the sequence of (1) to (3) as long as the inkjet printer 100 is not performing printing operations on the print target, such as when the inkjet printer is started up in the morning, when a production line is stopped during a lunch break, or when the inkjet printer is shut down in the evening. In addition, there are no particular limitations on the execution frequency, and the sequence may be executed daily, weekly, monthly, etc.

Furthermore, an operator can operate the inkjet printer 100 via the display unit 5 and execute the sequence of (1) to (3) at any time when the operator concerns about the print quality.

The optimal excitation voltage condition estimated in (2) and the ink quality state determination result and the peak ratio at the maximum value measured in (3) may be recorded in chronological order at any interval in the internal memory (the ROM 202 or the RAM 203) of the controller 200.

FIG. 10 is a diagram illustrating a configuration of a printing system of the inkjet printer. The printing system of FIG. 10 includes a plurality of inkjet printers 100-1 to 100-n, and a server 501 connected to the inkjet printers 100-1 to 100-n via a communication line 502. Data recorded and accumulated in the internal memory (the ROM 202 or the RAM 203) of the controller 200 of each of the inkjet printers 100-1 to 100-n is transmitted to the server 501 via the communication line 502. The server 501 then displays, for example, a determination result of an ink quality state.

FIG. 11 is a display screen illustrating a determination result of an ink quality state, and illustrates content of the display screen when the ink quality state is determined to be “favorable”. FIG. 12 is a display screen illustrating a determination result of an ink quality state, and illustrates content of the display screen when the ink quality state is determined to be “poor”.

This determination result can be used to diagnose the quality state of the ink, and when the quality state of the ink is determined to be “poor”, a dialogue box urging the user to replace the ink with ink in a favorable quality state can be displayed on a display screen of the server 501 or the display unit 5 of each of the inkjet printers 100-1 to 100-n.

Even when the quality state of the ink is determined to be “favorable” in (3), if the optimal excitation voltage condition of (2) significantly deviates from an initial state, it is possible to encourage ink replacement.

As described above, according to the third embodiment of the invention, by updating the set value of the excitation voltage under the excitation voltage condition under which the print quality is favorable and diagnosing the quality state of the ink from the R-V diagram automatically and periodically or at any timing, it is possible to provide a highly robust inkjet printer that achieves high print quality.

Here, “functions” of the “units” illustrated in FIG. 2 are realized by, for example, the processor (the MPU 201) executing a program.

For example, in the controller 200 illustrated in FIG. 2, the processor processor (the MPU 201) executes a program to realize a predetermined control function.

A characteristic measurement function of the characteristic measurement unit 273 is realized by the processor processor (the MPU 201) executing a program. An excitation voltage calculation function of the excitation voltage calculation unit 274 is realized by the processor processor (the MPU 201) executing a program. An ink quality state determination function of the ink quality state determination unit 275 is realized by the processor processor (the MPU 201) executing a program.

According to the embodiments, it is possible to realize a highly robust inkjet printer that realizes high print quality by determining the ink quality state and the excitation voltage condition under which the print quality is favorable.

### REFERENCE SIGNS LIST

1 Main body
2 Print head
5 Display unit
100 Inkjet printer
200 Controller
207 Electrification voltage generation circuit
208 Excitation voltage generation circuit
209 Storage device
210 Charging phase waveform measurement circuit
211 Nozzle
213 Electrification electrode
214 Deflection electrode
273 Characteristic measurement unit
274 Excitation voltage calculation unit
275 Ink quality state determination unit
501 Server
502 Communication line

1. An inkjet printer comprising:
a main body having an ink tank storing ink;
a print head configured to electrify ink particles generated by applying an excitation voltage to a piezoelectric element exciting the ink supplied from the ink tank to a nozzle to change a trajectory of the ink particles according to an amount of charge on the ink particles, thereby performing printing using the ink particles on a print target; and
a controller configured to control the print head,
wherein the controller is configured to:
measure a charging phase waveform representing a relationship between a charging phase and the amount of charge on ink droplets,
measure an excitation voltage characteristic representing a relationship between the excitation voltage and a feature amount calculated from the charging phase waveform, and
calculate an excitation voltage set value allowing printing based on the excitation voltage characteristic, and drive the piezoelectric element based on the calculated excitation voltage set value.

2. The inkjet printer according to claim 1, wherein the controller obtains a peak ratio of a maximum value to a minimum value of the electrification quantity of the charging phase waveform as the feature amount of the excitation voltage characteristic.

3. The inkjet printer according to claim 2, wherein the controller calculates the excitation voltage corresponding to a maximum point of the peak ratio included in the excitation voltage characteristic as the excitation voltage set value.

4. The inkjet printer according to claim 1, wherein the controller calculates the excitation voltage set value periodically or at any timing.

5. An inkjet printer comprising:
a main body having an ink tank storing ink;
a print head configured to electrify ink particles generated by applying an excitation voltage to a piezoelectric element exciting the ink supplied from the ink tank to a nozzle to change a trajectory of the ink particles according to an amount of charge on ink droplets, thereby performing printing using the ink particles on a print target; and
a controller configured to control the print head,
wherein the controller is configured to:
measure a charging phase waveform representing a relationship between a charging phase and the amount of charge on ink droplets, and
determine a quality state of the ink from the charging phase waveform.

6. The inkjet printer according to claim 5, wherein the controller is configured to:
measure an excitation voltage characteristic representing a relationship between the excitation voltage and a feature amount calculated from the charging phase waveform, and
determine the quality state of the ink based on the excitation voltage characteristic.

7. The inkjet printer according to claim 6, wherein the controller obtains a peak ratio of a maximum value to a minimum value of the electrification quantity of the charging phase waveform as the feature amount of the excitation voltage characteristic.

8. The inkjet printer according to claim 7, wherein the controller determines the quality state of the ink using a maximum point of the peak ratio included in the excitation voltage characteristic.

9. The inkjet printer according to claim 8, wherein the controller determines that the quality state of the ink is favorable when the maximum point is greater than a threshold value, and determines that the quality state of the ink is poor when the maximum point is less than the threshold value.

10. An inkjet printer comprising:
a main body having an ink tank storing ink;
a print head configured to electrify ink particles generated by applying an excitation voltage to a piezoelectric element exciting the ink supplied from the ink tank to a nozzle to change a trajectory of the ink particles according to an amount of charge on the ink particles, thereby performing printing using the ink particles on a print target;
a controller configured to control the print head; and
a display unit configured to display predetermined information, wherein:
the controller is configured to:
measure a charging phase waveform representing a relationship between a charging phase and the amount of charge on the ink particles,
measure an excitation voltage characteristic representing a relationship between the excitation voltage and a feature amount calculated from the charging phase waveform,
calculate an excitation voltage set value allowing printing based on the excitation voltage characteristic, and drive the piezoelectric element using the calculated excitation voltage set value,
control the print head based on the calculated excitation voltage set value, and
determine a quality state of the ink from the charging phase waveform, and
the display unit displays a determination result of the quality state of the ink.

11. The inkjet printer according to claim 10, wherein the controller obtains a peak ratio of a maximum value to a minimum value of the amount of charge of the charging phase waveform as the feature amount of the excitation voltage characteristic.

12. The inkjet printer according to claim 11, wherein the controller calculates the excitation voltage corresponding to a maximum point of the peak ratio included in the excitation voltage characteristic as the excitation voltage set value.

13. The inkjet printer according to claim 11, wherein the controller determines the quality state of the ink using a maximum point of the peak ratio included in the excitation voltage characteristic.

14. The inkjet printer according to claim 10, wherein:
the controller determines the quality state of the ink by calculating the excitation voltage set value periodically or at any timing, and
when the quality state of the ink is determined to be poor as a result of determination on the quality state of the ink, the display unit displays a dialogue box encouraging replacement with the ink, the quality state of which is favorable.

15. A printing system of an inkjet printer comprising:
at least one inkjet printer according to claim 10; and
a server connected to the inkjet printer via a communication line,
wherein the server displays a determination result of an ink quality state.
